(19) United States
(12) Patent Application Publication
(10) Pub. No.: US 2022/0389252 A1
(43) Pub. Date: Dec. 8, 2022

(54) INK COMPOSITION, RECORDING MEDIUM, INK-JET RECORDING APPARATUS, INK-JET RECORDING METHOD, AND INK CONTAINER

(71) Applicant: BROTHER KOGYO KABUSHIKI KAISHA, Nagoya (JP)

(72) Inventors: YUKA TSUZAKA, Nagoya (JP); MITSUNORI MAEDA, Nagoya (JP)

(73) Assignee: BROTHER KOGYO KABUSHIKI KAISHA, Nagoya (JP)

(21) Appl. No.: 17/826,281

(22) Filed: May 27, 2022

(30) Foreign Application Priority Data
May 31, 2021 (JP) 2021-091387

(51) Int. Cl. C09D 11/328; B41M 3/00

(52) U.S. Cl. CPC C09D 11/328; B41M 3/001

(57) ABSTRACT

A first ink composition includes: water; a water-soluble organic solvent; and a color developing agent. The color developing agent includes a pH indicator. The water-soluble organic solvent includes at least one water-soluble organic solvent having a SP value of 16 or less and 11 or more. An amount of the water-soluble organic solvent having a SP value of 16 or less and 11 or more in the first ink composition is 15 wt % or more. A second ink composition includes: water; a water-soluble organic solvent; and a color developing agent. The color developing agent includes a pH indicator. The water-soluble organic solvent includes at least one water-soluble organic solvent having a SP value of 16 or less. An amount of the water-soluble organic solvent having a SP value of 16 or less in the second ink composition is 15 wt % or more. The second ink composition is a water-based ink for ink-jet recording.

### CROSS REFERENCE TO RELATED APPLICATIONS

This application claims priority from Japanese Patent Application No. 2021-091387 filed on May 31, 2021. The entire disclosure of the Japanese Patent Application is incorporated herein by reference.

### BACKGROUND

### Technical Field

The present disclosure relates to an ink composition, a recording medium, an ink-jet recording apparatus, an ink-jet recording method, and an ink container.

### Related Art

Erasable inks may include a pH indicator which develops color in an alkaline state, for example, with phenolphthalein or the like, and erases color in a neutral state.

### SUMMARY

An aspect of the present disclosure is an ink composition which includes: water; a water-soluble organic solvent; and a color developing agent, wherein the color developing agent includes a pH indicator, the water-soluble organic solvent includes at least one water-soluble organic solvent having a solubility parameter (SP) value of 16 or less and 11 or more, and an amount of the water-soluble organic solvent having a SP value of 16 or less and 11 or more in the ink composition is 15 wt % or more.

Another aspect of the present disclosure is an ink composition which includes: water; a water-soluble organic solvent; and a color developing agent, wherein the color developing agent includes a pH indicator, the water-soluble organic solvent includes at least one water-soluble organic solvent having a SP value of 16 or less, an amount of the water-soluble organic solvent having a SP value of 16 or less in the ink composition is 15 wt % or more, and the ink composition is a water-based ink for ink-jet recording.

A further aspect of the present disclosure is a recording medium including a substrate and the above-described ink composition, printed on the substrate.

A further aspect of the present disclosure is an ink-jet recording apparatus including the above-described ink composition, a flow path, and an ink ejection unit. The ink composition is supplied to the flow path in operation. The ink ejection unit is configured to eject the ink composition supplied to the flow path to a recording medium.

A further aspect of the present disclosure is an ink-jet recording method including ejecting the above-described ink composition on a recording medium.

A further aspect of the present disclosure is an ink container including the above-described ink composition.

The foregoing paragraphs have been provided by way of general introduction and are not intended to limit the scope of the following claims. The described embodiments, together with further advantages, will be best understood by reference to the following detailed description taken in conjunction with the accompanying drawing.

### BRIEF DESCRIPTION OF THE DRAWINGS

The FIGURE is a schematic perspective view showing a configuration of an exemplary ink-jet recording apparatus.

### DETAILED DESCRIPTION OF EMBODIMENTS

Embodiments of the present disclosure will now be described more fully hereinafter with reference to the accompanying drawing, in which some, but not all of the embodiments of the disclosure are shown.

As used herein, the words “a” and “an” and the like carry the meaning of “one or more.”. When an amount, concentration, or other value or parameter is given as a range, and/or its description includes a list of upper and lower values, this is to be understood as specifically disclosing all integers and fractions within the given range, and all ranges formed from any pair of any upper and lower values, regardless of whether subranges are separately disclosed. Where a range of numerical values is recited herein, unless otherwise stated, the range is intended to include the endpoints thereof, as well as all integers and fractions within the range. As an example, a stated range of 1-10 fully describes and includes the independent subrange 3.4-7.2 as does the following list of values: 1, 4, 6, 10.

The present inventors found that a pH indicator has poor solubility in some solvents used for erasable inks, causing the printer to clog. The poor solubility limits the amount of pH indicator contained in the ink, resulting in a low initial optical density (OD) value. When the pH indicator concentration is increased to improve the OD value, it is necessary to increase the amount of solubility enhancers such as sodium hydroxide. This increases the pH of the ink, which makes it difficult for the ink to be decolorized (erased), i.e., it is difficult to achieve both initial OD value and decolorizing ability.

An exemplary ink composition of the present disclosure (hereinafter, referred to as a “first ink composition”) includes: water; a water-soluble organic solvent; and a color developing agent, wherein the color developing agent includes a pH indicator, the water-soluble organic solvent includes at least one water-soluble organic solvent having a SP value of 16 or less and 11 or more, and an amount of the water-soluble organic solvent having a SP value of 16 or less and 11 or more in the first ink composition is 15 wt % or more. A further exemplary ink composition of the present disclosure (hereinafter, referred to as a “second ink composition”) includes: water; a water-soluble organic solvent; and a color developing agent, wherein the color developing agent includes a pH indicator, the water-soluble organic solvent includes at least one water-soluble organic solvent having a SP value of 16 or less, an amount of the water-soluble organic solvent having a SP value of 16 or less in the second ink composition is 15 wt % or more, and the second ink composition is a water-based ink for ink-jet recording. An ink composition suitable for ink-jet recording has a viscosity at 25° C. of from about 0.1 to about 100 mPa·s, preferably from about 1 to 50 mPa·s to be appropriately ejected from an ink jet nozzle. In the present disclosure, the first ink composition and the second ink composition are collectively referred to as an “ink composition” (hereinafter, sometimes referred to as a “water-based ink”, an “ink”, or an “erasable ink”).

The color developing agent may or may not contain, for example, a color developing agent other than a pH indicator. When the color developing agent does not contain a color developing agent other than a pH indicator, for example, the erasing ability of an erasable ink is improved, which ensures that the recording content cannot be observed after erasing the color.

The pH indicator is, for example, a reagent which discolors by a change in hydrogen ion concentration (change in pH) in a solution, a reagent which develops color in an alkaline state (for example, pH 9.8 to 13.4), a reagent that softens in shade of color as pH is shifted to a neutral side, and/or a reagent that erases (fades) color when pH is in a neutral state (for example, pH 8.5 or less). A specific example of a pH indicator is at least one selected from the group consisting of phenolphthalein, thymolphthalein, and o-cresolphthalein. A single pH indicator may be used alone or two or more different pH indicators may be used in combination. The amount of the pH indicator is not particularly limited, and, in embodiments, may be in the range, for example, from 0.1 wt % to 3.0 wt %, preferably from 0.1 wt % to 0.8 wt %, more preferably from 0.2 wt % to 0.8 wt %.

In the first ink composition, the water-soluble organic solvent includes, as described above, a water-soluble organic solvent having a SP value of 16 or less and 11 or more. In the second ink composition, the water-soluble organic solvent includes, as described above, a water-soluble organic solvent having at least one SP value of 16 or less. The SP value is a value determined using the following equation according to the Fedors method, and the unit of the SP value is (cal/cm³)^{1/2}.

SP value=(ΣΔei/ΣΔvi)^{1/2}

Δei: evaporation energy of atoms and atomic groups (cal/mol)
Δvi: molar volume (cm³/mol)

As the water-soluble organic solvent having a SP value of 16 or less and 11 or more in the first ink composition, any water-soluble organic solvent may be used as long as it is a water-soluble organic solvent having a SP value of 16 or less and 11 or more. The water-soluble organic solvent having a SP value of 16 or less and 11 or more may include one or more humectants for preventing the ink from drying at a nozzle tip of an ink-jet head and/or one or more penetrants for adjusting a drying speed on a recording medium, so long as the humectants or the penetrants have a SP value of 16 or less and 11 or more. Specific examples of the water-soluble organic solvent having a SP value of 16 or less and 11 or more include methanol (SP value: 14.5 to 14.8), ethanol (SP value: 12.7), isopropanol (SP value: 11.5), n-butanol (SP value: 11.3), a polyethylene glycol (SP value: 12.0) with a molecular weight of 200 or more, diethylene glycol (SP value: 14.6), propylene glycol (SP value: 13.5), triethylene glycol (SP value: 13.6), tripropylene glycol (SP value: 11.5), 1,2-hexanediol (SP value: 11.8), and 2-pyrrolidone (SP value: 11.4). Among them, the first ink composition may preferably include triethylene glycol, a polyethylene glycol having a molecular weight of 200 or more, or both. One kind of water-soluble organic solvent having a SP value of 16 or less and 11 or more may be used alone, or two or more kinds of them may be used in combination. In the latter case, the total amount of the two or more kinds of the water-soluble organic solvents having a SP value of 16 or less and 11 or more is 15 wt % or more relative to the total weight of the ink composition. In the water-soluble organic solvent in the first ink composition, a lower limit of the SP value is, for example, 12, or 13. In the water-soluble organic solvent, when the SP value is 11 or more, for example, a time until the erasable ink is erased (erasing time) becomes longer as compared with a case where the SP value is less than 11, for example. The erasing time is, for example, from 6 hours to 72 hours. In this instance, the details of what is printed on a recording medium using an erasable ink is visible on the day of recording, but after several days, the details of what printed on the printed matter is erased and becomes invisible. For this reason, the first ink composition may be used to perform secure printing, for example.

As the water-soluble organic solvent having a SP value of 16 or less in the second ink composition, any water-soluble organic solvent may be used as long as it is a water-soluble organic solvent having a SP value of 16 or less. The water-soluble organic solvent having a SP value of 16 or less may include one or more humectants for preventing the ink from drying at a nozzle tip of an ink-jet head and/or one or more penetrants for adjusting a drying speed on a recording medium, so long as the humectants or the penetrants have a SP value of 16 or less. Specific examples of the water-soluble organic solvent having a SP value of 16 or less include methanol (SP value: 14.5 to 14.8), ethanol (SP value: 12.7), isopropanol (SP value: 11.5), n-butanol (SP value: 11.3), those having a SP value of 16 or less out of polyethylene glycols with a molecular weight of 200 or more (for example, polyethylene glycol (SP value: 12.0) with a molecular weight of 200), diethylene glycol (SP value: 14.6), propylene glycol (SP value: 13.5), triethylene glycol (SP value: 13.6), polypropylene glycols having a SP value of 16 or less, tripropylene glycol (SP value: 11.5), 1,2-hexanediol (SP value: 11.8), propylene glycol monomethyl ether (SP value: 10.2), triethylene glycol monobutyl ether (SP value: 10.3), triethylene glycol-n-butyl ether (SP value: 9.8), tripropylene glycol-n-butyl ether (SP value: 9.2), and 2-pyrrolidone (SP value: 11.4). As the water-soluble organic solvent having a SP value of 16 or less, a diol type (i.e., bifunctional) polyalkylene glycol may be included. A single water-soluble organic solvent having a SP value of 16 or less may be used alone, or two or more may be used in combination. In the latter case, a total amount of two or more kinds of the water-soluble organic solvents having a SP value of 16 or less is 15 wt % or more relative to the total weight of the ink composition.

The water-soluble organic solvent included in the first or second ink composition may or may not include water-soluble organic solvents other than the water-soluble organic solvent having a SP value of 16 or less and 11 or more in the first ink composition or the water-soluble organic solvent having a SP value of 16 or less in the second ink composition. Examples of the other water-soluble organic solvent include humectants for preventing the ink from drying at a nozzle tip of an ink-jet head and penetrants for adjusting a drying speed on a recording medium. The SP value of the other water-soluble organic solvent is not particularly limited, but from the viewpoint of the solubility of the pH indicator contained in the color developing agent, other water-soluble organic solvents with SP values exceeding 16 preferably are not included.

The first or second ink composition may include one or more humectants. Some humectants are within the scope of the water-soluble organic solvent having a SP value of 16 or less and 11 or more in the first ink composition, and some are not. An amount of humectants having a SP value of 16 or less and 11 or more is included in the amount of the water-soluble organic solvent having a SP value of 16 or less and 11 or more, when the amount of the water-soluble organic solvent having a SP value of 16 or less and 11 or more is calculated. Further, Some humectants are within the scope of the water-soluble organic solvent having a SP value of 16 or less in the second ink composition, and some are not. An amount of humectants having a SP value of 16 or less is included in the amount of the water-soluble organic solvent having a SP value of 16 or less, when the amount of the water-soluble organic solvent having a SP value of 16 or less is calculated. Humectants are not particularly limited, and examples thereof include lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols such as diacetone alcohol; ethers such as tetrahydrofuran and dioxane; polyethers such as polyalkylene glycols; polyhydric alcohols such as alkylene glycol, glycerin, trimethylolpropane, and trimethylolethane; 2-pyrrolidone; N-methyl-2-pyrrolidone; and 1,3-dimethyl-2-imidazolidinone. Examples of the polyalkylene glycol include polyethylene glycol and polypropylene glycol. Examples of the alkylene glycol include ethylene glycol, propylene glycol, butylene glycol, diethylene glycol, triethylene glycol, dipropylene glycol, tripropylene glycol, thiodiglycol, and hexylene glycol. One kind of the humectants may be used alone or two or more kinds of them may be used in combination.

The amount of the humectant relative to the total amount of the ink composition may be in the range, for example, from 0 wt % to 84.9 wt %, preferably 0 wt % to 20 wt %, more preferably 0 wt % to 2 wt %.

The first or second ink composition may include one or more penetrants. Some penetrants are within the scope of the water-soluble organic solvent having a SP value of 16 or less and 11 or more in the first ink composition, and some are not. An amount of penetrants having a SP value of 16 or less and 11 or more is included in the amount of the water-soluble organic solvent having a SP value of 16 or less and 11 or more, when the amount of the water-soluble organic solvent having a SP value of 16 or less and 11 or more is calculated. Some penetrants are within the scope of the water-soluble organic solvent having a SP value of 16 or less in the second ink composition, and some are not. An amount of penetrants having a SP value of 16 or less is included in the amount of the water-soluble organic solvent having a SP value of 16 or less, when the amount of the water-soluble organic solvent having a SP value of 16 or less is calculated. The penetrant may be, for example, a glycol ether. Examples of the glycol ether include ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, and tripropylene glycol-n-butyl ether. A single penetrant may be used alone or two or more penetrants may be used in combination.

The amount of the penetrant relative to the total amount of the ink composition may be in the range, for example, from 0 wt % to 84.9 wt %, preferably from 0 wt % to 20 wt %, more preferably from 0 wt % to 2 wt %.

The ink composition may include, for example, one or more pH adjusters. Examples of the pH adjuster include an alkali metal hydroxide, an alkali metal carbonate, a hydroxide of a Group II to Group XII element, a carbonate of a Group II to Group XII element, and an amine. Specific examples of the pH adjuster include sodium hydrogen carbonate, potassium carbonate, calcium carbonate, sodium hydroxide, sodium carbonate, triethanolamine, N-butyldiethanolamine, sodium citrate (disodium citrate, trisodium citrate), sodium hydrogen carbonate, potassium phosphate (potassium dihydrogen phosphate, dipotassium hydrogen phosphate, tripotassium phosphate), trisodium phosphate, sodium hydrogen phosphate (disodium hydrogen phosphate, sodium dihydrogen phosphate), and sodium dihydrogen pyrophosphate. A single pH adjuster may be used alone or two or more pH adjusters may be used in combination. The amount of the pH adjuster in the ink composition may be, for example, 5 wt % or less, preferably 3 wt % or less.

The water may be, for example, ion-exchanged water or pure water. The amount (water ratio) of the water relative to the total amount of the ink composition is appropriately determined according to desired ink characteristics and the like. The water ratio may be, for example, a balance of the other components. The amount of the water may be in the range of, for example, from 60 wt % to 90 wt %, preferably, from 65 wt % to 85 wt %, more preferably from 70 wt % to 85 wt %.

The ink composition may further contain one or more other additives as needed. Examples of other additives include a surfactant, a viscosity modifier, a surface tension modifier, and a mildewproofing agent. Examples of the viscosity modifier include polyvinyl alcohol, cellulose, and a water-soluble resin.

The ink composition may be used, for example, for ink-jet recording. The ink composition may also be used in applications such as, for example, writing instruments such as pens, markers, and brushes; and coating materials.

Next, the ink container which includes the ink composition will be described. Examples of the ink set container include an ink cartridge, a tank, and a pouch. As the main body of the ink container, for example, a conventionally known main body may be used.

Next, the ink-jet recording apparatus and the ink-jet recording method will be described.

The ink-jet recording apparatus includes a flow path and an ink ejection unit, wherein an ink supplied to the flow path is ejected by the ink ejection unit, and the ink composition is supplied to the flow path.

The FIGURE shows a configuration of an example of the ink-jet recording apparatus. As shown in the FIGURE, the ink-jet recording apparatus 1 includes an ink cartridge 2, an ink ejection unit (ink-jet head) 3, a head unit 4, a carriage 5, a drive unit 6, a platen roller 7, and a purge device 8 as main components. Although it is not shown in the FIGURE, the ink cartridge 2 and the ink ejection unit 3 are connected by a flow path, the ink composition is supplied from the ink cartridge 2 containing the ink composition to the flow path, and the ink ejection unit 3 ejects the ink composition on a recording medium.

The ink cartridge 2 contains the ink composition, for example. As the main body of the ink cartridge, for example, a conventionally known main body may be used.

Also, although it is not shown in the FIGURE, the ink-jet recording apparatus 1 may include, in addition to the ink cartridge 2 containing the ink composition, a set of four ink cartridges each containing each of four water-based color inks, yellow, magenta, cyan, and black. In addition, in place of the set of four ink cartridges, an integrated ink cartridge, the inside thereof is partitioned so as to form a water-based yellow ink storage portion, a water-based magenta ink storage portion, a water-based cyan ink storage portion, and a water-based black ink storage portion, may be used.

The ink-jet head 3 installed in the head unit 4 performs recording on a recording medium (for example, recording paper) P. The ink cartridge 2 and the head unit 4 are mounted on the carriage 5. The drive unit 6 reciprocates the carriage 5 in the linear direction. As the drive unit 6, for example, a conventionally known drive unit may be used (see, for example, US2008/241398, the contents of which are hereby incorporated into the present specification). The platen roller 7 extends in the reciprocating direction of the carriage 5 and is disposed to face the ink-jet head 3.

The purge device 8 sucks defective ink containing bubbles and the like pooled inside the ink-jet head 3. As the purge device 8, for example, a conventionally known purge device may be used (see, for example, US2008/241398).

On the platen roller 7 side of the purge device 8, a wiper member 20 is disposed adjacent to the purge device 8. The wiper member 20 is formed in a spatula shape and is configured to wipe the nozzle forming surface of the ink-jet head 3 in accordance with the movement of the carriage 5. In the FIGURE, the cap 18 is configured to cover a plurality of nozzles of the ink-jet head 3 which are configured to return to the reset position when the recording is completed, in order to prevent the ink from drying.

In the ink-jet recording apparatus 1 of the present embodiment, the ink cartridge 2 is mounted on one carriage 5 together with the head unit 4. However, the ink-jet recording apparatus 1 is not limited thereto. In the ink-jet recording apparatus 1, the ink cartridge 2 may be mounted on a carriage which is different from the one on which the head unit 4 is mounted. The ink cartridge 2 may be disposed and fixed in the ink-jet recording apparatus 1 without being mounted on the carriage 5. In these embodiments, for example, the ink cartridge 2 and the head unit 4 mounted on the carriage 5 are connected by the flow path such as a tube, and the ink is supplied from the ink cartridge 2 to the head unit 4. In these embodiments, a bottle-shaped ink bottle may be used instead of the ink cartridge 2. In this case, an inlet through which an ink is injected from the outside into the inside may be provided in the ink bottle, for example.

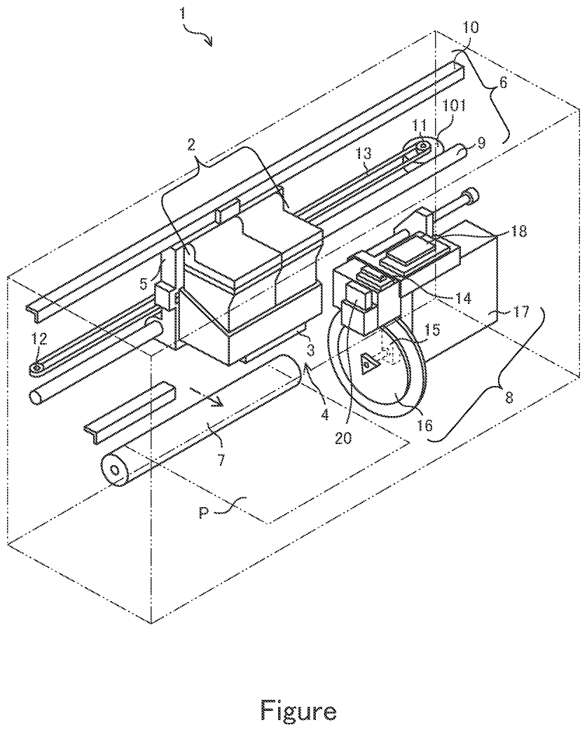

Ink-jet recording using the ink-jet recording apparatus 1 is performed, for example, as follows. First, the recording paper P is fed from a paper feed cassette (not shown) provided on the side or below the ink-jet recording apparatus 1. The recording paper P is introduced between the ink-jet head 3 and the platen roller 7. On the introduced recording paper P, a predetermined recording is performed by the water-based ink ejected from the ink-jet head 3. The recording sheet P after recording is ejected from the ink-jet recording apparatus 1. In FIG. 1, a sheet feeding mechanism and a sheet ejecting mechanism of the recording sheet P are not shown.

Although the apparatus shown in FIG. 1 employs a serial ink-jet head, the apparatus is not limited thereto. The ink-jet recording apparatus may be an apparatus that employs a line ink-jet head or the printing apparatus may be a roll-to-roll printing apparatus.

Next, the ink-jet recording method for recording by ejecting the ink composition on a recording medium by an ink-jet method, will be described. The ink-jet recording method may be performed, for example, using the ink-jet recording apparatus. The recording includes character-printing, image-printing, printing, and the like.

### EXAMPLES

Examples and comparative examples are described below. The present invention, however, is not limited by the following examples and comparative examples.

(Preparation of Erasable Ink)

Components of the erasable ink composition summarized in Table 1 were uniformly mixed to obtain erasable inks of Examples 1 to 13. Further, components of the erasable ink composition summarized in Table 2 were uniformly mixed to obtain erasable inks of Comparative Examples 1 to 5. The solubility of the color developing agent in the erasable inks of Examples 1 to 13 and Comparative Examples 1 to 5 was evaluated. The erasable inks of Examples 1 to 13 and Comparative Examples 1 to 5 were applied to recording paper (trade name: ASKUL Super White+, ASKUL Corporation), and the initial OD value, the visibility on the day of recording, and the erasing ability were examined by the following methods. The test results of the erasable inks are also summarized in Tables 1 and 2 below.

TABLE 1

| | | | Ex. 1 | Ex. 2 | Ex. 3 | Ex. 4 | Ex. 5 | Ex. 6 | Ex. 7 |
|---|---|---|---|---|---|---|---|---|---|
| Composition | Color developing agent | Thymolphthalein | 0.5 | 0.5 | 0.5 | 0.5 | 0.5 | | |
| | (pH indicator) | Phenolphthalein | | | | | | 0.5 | |
| | | o-cresolphthalein | | | | | | | 0.5 |
| | Water-soluble organic | Triethylene glycol (SP value: 13.6) | 15.0 | 20.0 | | | 18.0 | 20.0 | 20.0 |
| | solvent | Polyethylene glycol (molecular weight: 200) | | | 18.0 | | | | |
| | | (SP value: 12.0) | | | | | | | |
| | | Tripropylene glycol | | | | 20.0 | | | |
| | | (SP value: 11.5) | | | | | | | |
| | | Glycerin | | | | | 2.0 | | |
| | | (SP value: 17.5) | | | | | | | |
| | | Triethylene glycol monobutyl ether | | | | | 2.0 | | |
| | | (SP value: 10.3) | | | | | | | |
| | Surfactant | SURFYNOL ® 440 | 0.5 | 0.5 | 0.5 | 0.5 | 0.5 | 0.5 | 0.5 |
| | | (SP value: 10) | | | | | | | |
| | pH adjuster | Sodium hydroxide | 2.4 | 2.4 | 2.4 | 2.4 | 2.4 | 2.4 | 2.4 |
| | Solvent | Water | 81.6 | 76.6 | 78.6 | 76.6 | 74.6 | 76.6 | 76.6 |
| Results | Solubility | A: completely dissolved. | A | A | A | A | A | A | A |
| | | B: precipitate was formed at room temperature | | | | | | | |
| | | 1 month after stirring. | | | | | | | |
| | | C: precipitate was observed immediately after | | | | | | | |
| | | stirring. | | | | | | | |
| | Initial OD value | A: equation (1) was achieved or OD value was | 0.50 | 0.50 | 0.48 | 0.48 | 0.50 | 0.45 | 0.43 |
| | | 0.40 or more. | | | | | | | |
| | | B: equation (1) was achieved or OD value was | | | | | | | |
| | | 0.25 or more. | | | | | | | |
| | | C: equation (1) was not achieved and OD value | | | | | | | |
| | | was 0.25 or less. | | | | | | | |
| | | Equation (1) y > 0.75x + 0.05 | | | | | | | |
| | | x: amount of pH indicator in ink | | | | | | | |
| | | y: OD value | | | | | | | |
| | Visibility on the day of | A: OD value difference between recorded paper | 0.35 | 0.35 | 0.33 | 0.32 | 0.35 | 0.25 | 0.35 |
| | recording | and blank paper was 0.10 or more. | | | | | | | |
| | (OD value after 6 h) | B: OD value difference between recorded paper | | | | | | | |
| | | and blank paper was less than 0.10. | | | | | | | |
| | Erasing ability | A: OD value difference between recorded paper | 0.01 | 0.01 | 0.01 | 0.01 | 0.01 | 0.02 | 0.01 |
| | (OD value after 72 h) | and blank paper was less than 0.03. | | | | | | | |
| | | B: OD value difference between recorded paper | | | | | | | |
| | | and blank paper was less than 0.10. | | | | | | | |
| | | C: OD value difference between recorded paper | | | | | | | |
| | | and blank paper was 0.10 or more. | | | | | | | |

| | | | Ex. 8 | Ex. 9 | Ex. 10 | Ex. 11 | Ex. 12 | Ex. 13 |
|---|---|---|---|---|---|---|---|---|
| Composition | Color developing agent | Thymolphthalein | 0.2 | 0.1 | 1.0 | 1.0 | 4.0 | 0.5 |
| | (pH indicator) | Phenolphthalein | | | | | | |
| | | o-cresolphthalein | | | | | | |
| | Water-soluble organic | Triethylene glycol (SP value: 13.6) | 20.0 | 20.0 | 20.0 | 20.0 | 20.0 | |
| | solvent | Polyethylene glycol (molecular weight: 200) | | | | | | |
| | | (SP value: 12.0) | | | | | | |
| | | Tripropylene glycol | | | | | | |
| | | (SP value: 11.5) | | | | | | |
| | | Glycerin | | | | | | |
| | | (SP value: 17.5) | | | | | | |
| | | Triethylene glycol monobutyl ether | | | | | | 15.0 |
| | | (SP value: 10.3) | | | | | | |
| | Surfactant | SURFYNOL ® 440 | 0.5 | 0.5 | 0.5 | 0.5 | 0.5 | 0.5 |
| | | (SP value: 10) | | | | | | |
| | pH adjuster | Sodium hydroxide | 2.4 | 2.4 | 2.4 | 4.8 | 4.8 | 2.4 |
| | Solvent | Water | 76.9 | 77.0 | 76.1 | 73.7 | 70.7 | 81.6 |
| Results | Solubility | A: completely dissolved. | A | A | B | A | B | A |
| | | B: precipitate was formed at room temperature 1 | | | | | | |
| | | month after stirring. | | | | | | |
| | | C: precipitate was observed immediately after | | | | | | |
| | | stirring. | | | | | | |
| | Initial OD value | A: equation (1) was achieved or OD value was | 0.35 | 0.22 | 0.72 | 0.72 | 0.97 | 0.53 |
| | | 0.40 or more. | | | | | | |
| | | B: equation (1) was achieved or OD value was | | | | | | |
| | | 0.25 or more. | | | | | | |
| | | C: equation (1) was not achieved and OD value | | | | | | |
| | | was 0.25 or less. | | | | | | |
| | | Equation (1) y > 0.75x + 0.05 | | | | | | |
| | | x: amount of pH indicator in ink | | | | | | |
| | | y: OD value | | | | | | |
| | Visibility on the day of | A: OD value difference between recorded paper | 0.22 | 0.12 | 0.60 | 0.68 | 0.78 | 0.03 |
| | recording | and blank paper was 0.10 or more. | | | | | | |
| | (OD value after 6 h) | B: OD value difference between recorded paper | | | | | | |
| | | and blank paper was less than 0.10. | | | | | | |
| | Erasing ability | A: OD value difference between recorded paper | 0.01 | 0.01 | 0.02 | 0.05 | 0.09 | 0.01 |
| | (OD value after 72 h) | and blank paper was less than 0.03. | | | | | | |
| | | B: OD value difference between recorded paper | | | | | | |
| | | and blank paper was less than 0.10. | | | | | | |
| | | C: OD value difference between recorded paper | | | | | | |
| | | and blank paper was 0.10 or more. | | | | | | |

TABLE 2

| | | | Com. | Com. | Com. | Com. | Com. |
|---|---|---|---|---|---|---|---|
| | | | Ex. 1 | Ex. 2 | Ex. 3 | Ex. 4 | Ex. 5 |
| Composition | Color developing agent | Thymolphthalein | 0.5 | 0.5 | | | |
| | (pH indicator) | | | | | | |
| | | Phenolphthalein | | | 0.5 | 0.1 | |
| | | o-cresolphthalein | | | | | 0.5 |
| | Water-soluble organic | Triethylene glycol (SP value: 13.6) | | 10.0 | | | |
| | solvent | Polyethylene glycol (molecular weight: 200) | | | | | |
| | | (SP value: 12.0) | | | | | |
| | | Tripropylene glycol | | | | | |
| | | (SP value: 11.5) | | | | | |
| | | Glycerin | 20.0 | | 15.0 | 20.0 | 15.0 |
| | | (SP value: 17.5) | | | | | |
| | | Triethylene glycol monobutyl ether | | | | | |
| | | (SP value: 10.3) | | | | | |
| | Surfactant | SURFYNOL ® 440 | 0.5 | 0.5 | 0.5 | 0.5 | 0.5 |
| | | (SP value: 10) | | | | | |
| | pH adjuster | Sodium hydroxide | 2.4 | 2.4 | 2.4 | 2.4 | 2.4 |
| | Solvent | Water | 76.6 | 86.6 | 81.6 | 77.0 | 81.6 |
| Results | Solubility | A: completely dissolved. | C | C | C | B | C |
| | | B: precipitate was formed at room temperature 1 | | | | | |
| | | month after stirring. | | | | | |
| | | C: precipitate was observed immediately after | | | | | |
| | | stirring. | | | | | |
| | Initial OD value | A: equation (1) was achieved or OD value was | 0.34 | 0.40 | 0.36 | 0.10 | 0.33 |
| | | 0.40 or more. | | | | | |
| | | B: equation (1) was achieved or OD value was | | | | | |
| | | 0.25 or more. | | | | | |
| | | C: equation (1) was not achieved and OD value | | | | | |
| | | was 0.25 or less. | | | | | |
| | | Equation (1) y > 0.75x + 0.05 | | | | | |
| | | x: amount of pH indicator in ink | | | | | |
| | | y: OD value | | | | | |
| | Visibility on the day of | A: OD value difference between recorded paper | 0.22 | 0.28 | 0.17 | 0.05 | 0.18 |
| | recording | and blank paper was 0.10 or more. | | | | | |
| | (OD value after 6 h) | B: OD value difference between recorded paper | | | | | |
| | | and blank paper was less than 0.10. | | | | | |
| | Erasing ability | A: OD value difference between recorded paper | 0.02 | 0.02 | 0.01 | 0.02 | 0.01 |
| | (OD value after 72 h) | and blank paper was less than 0.03. | | | | | |
| | | B: OD value difference between recorded paper | | | | | |
| | | and blank paper was less than 0.10. | | | | | |
| | | C: OD value difference between recorded paper | | | | | |
| | | and blank paper was 0.10 or more. | | | | | |

(Solubility)

The solubility of each erasable ink was evaluated after mixing the components based on the following criteria.

A: completely dissolved.
B: precipitate was formed at room temperature 1 month after stirring.
C: precipitate was observed immediately after stirring.

(Initial OD Value)

The initial OD value (optical density) was measured by a spectrocolorimeter SpectroEye® (light source: D50, viewing angle: 2°, ANSI-T) produced by X-Rite immediately after application of each erasable ink, and evaluated based on the following criteria.

A: equation (1) was achieved or OD value was 0.40 or more.
B: equation (1) was achieved or OD value was 0.25 or more.
C: equation (1) was not achieved and OD value was 0.25 or less.

y>0.75x+0.05 Equation (1)

x: amount of pH indicator in ink
y: OD value

(Visibility on the Day of Recording)

The OD value was measured after 6 hours standing after recording of each ink on a recording medium and the visibility on the day of recording was evaluated based on the following criteria.

A: OD value difference between recorded paper and blank paper was 0.10 or more.
B: OD value difference between recorded paper and blank paper was less than 0.10.

(Erasing Ability)

The OD value was measured after 72 hours (3 days) standing after recording of each ink on a recording medium and the erasing ability was evaluated based on the following criteria.

A: OD value difference between recorded paper and blank paper was less than 0.03.
B: OD value difference between recorded paper and blank paper was less than 0.10.
C: OD value difference between recorded paper and blank paper was 0.10 or more.

As summarized in Tables 1 and 2, all of the erasable inks of Examples 1 to 13 had a good evaluation (A or B) of solubility, initial OD value, and erasing ability. Furthermore, all of the erasable inks of Examples 1 to 13 had a good evaluation (A) of visibility on the day of recording. Therefore, from the viewpoint of achieving both visibility on the day of recording and the erasing ability, the SP value of the water-soluble organic solvent is preferably 16 or less and 11 or more in the erasable ink. On the other hand, all of the erasable inks of Comparative Examples 1 to 3 and 5 had a poor evaluation (C) of solubility, and a precipitate was observed immediately after stirring. In addition, the erasable ink of Comparative Example 4 had a poor evaluation (C) of initial OD and visibility on the day of recording, and the recorded image was blurry. Thus, the ink compositions of the examples exhibited excellent solubility, initial OD value, and decolorizing ability.

It will be obvious to those having skill in the art that many changes may be made in the above-described details of the particular aspects described herein without departing from the spirit or scope of the invention as defined in the appended claims.

What is claimed is:

1. An ink composition, comprising:
water;
a water-soluble organic solvent; and
a color developing agent, wherein
the color developing agent comprises a pH indicator,
the water-soluble organic solvent comprises at least one water-soluble organic solvent having a SP value of 16 or less and 11 or more, and
an amount of the water-soluble organic solvent having a SP value of 16 or less and 11 or more in the ink composition is 15 wt % or more.

2. An ink composition, comprising:
water;
a water-soluble organic solvent; and
a color developing agent, wherein
the color developing agent comprises a pH indicator,
the water-soluble organic solvent comprises at least one water-soluble organic solvent having a SP value of 16 or less,
an amount of the water-soluble organic solvent having a SP value of 16 or less in the ink composition is 15 wt % or more, and
the ink composition is a water-based ink for ink-jet recording.

3. The ink composition according to claim 1, wherein
the pH indicator comprises at least one selected from the group consisting of phenolphthalein, thymolphthalein, and o-cresolphthalein.

4. The ink composition according to claim 1, wherein
an amount of the pH indicator in the ink composition is from 0.1 wt % to 3.0 wt %.

5. The ink composition according to claim 1, wherein
an amount of the pH indicator in the ink composition is from 0.1 wt % to 0.8 wt %.

6. The ink composition according to claim 1, wherein
an amount of the pH indicator in the ink composition is from 0.2 wt % to 0.8 wt %.

7. The ink composition according to claim 1, wherein
the water-soluble organic solvent having a SP value of 16 or less and 11 or more comprises a diol type polyalkylene glycol.

8. The ink composition according to claim 1, further comprising:
a pH adjuster, wherein
an amount of the pH adjuster in the ink composition is 5 wt % or less.

9. The ink composition according to claim 8, wherein
an amount of the pH adjuster in the ink composition is 3 wt % or less.

10. A recording medium comprising:
a substrate; and
the ink composition according to claim 1, printed on the substrate.

11. An ink-jet recording apparatus, comprising:
the ink composition according to claim 1;
a flow path to which the ink composition is supplied in operation; and
an ink ejection unit configured to eject the ink composition supplied to the flow path to a recording medium.

12. An ink-jet recording method, comprising
ejecting the ink composition according to claim 1 on a recording medium.

13. An ink container, comprising the ink composition according to claim 1.

14. The ink composition according to claim 2, wherein
the pH indicator comprises at least one selected from the group consisting of phenolphthalein, thymolphthalein, and o-cresolphthalein.

15. The ink composition according to claim 2, wherein
an amount of the pH indicator in the ink composition is from 0.1 wt % to 3.0 wt %.

16. The ink composition according to claim 2, wherein
an amount of the pH indicator in the ink composition is from 0.1 wt % to 0.8 wt %.

17. The ink composition according to claim 2, wherein
an amount of the pH indicator in the ink composition is from 0.2 wt % to 0.8 wt %.

18. The ink composition according to claim 2, wherein
the water-soluble organic solvent having a SP value of 16 or less comprises a diol type polyalkylene glycol.

19. The ink composition according to claim 2, further comprising:
a pH adjuster, wherein
an amount of the pH adjuster in the ink composition is 5 wt % or less.

20. The ink composition according to claim 19, wherein
an amount of the pH adjuster in the ink composition is 3 wt % or less.

21. A recording medium comprising:
a substrate; and
the ink composition according to claim 2, printed on the substrate.

22. An ink-jet recording apparatus, comprising:
the ink composition according to claim 2;
a flow path to which the ink composition is supplied in operation; and
an ink ejection unit configured to eject the ink composition supplied to the flow path to a recording medium.

23. An ink-jet recording method, comprising
ejecting the ink composition according to claim 2 on a recording medium.

24. An ink container, comprising the ink composition according to claim 2.
